(19) United States
(12) Patent Application Publication
(10) Pub. No.: US 2014/0222951 A1
(43) Pub. Date: Aug. 7, 2014

(54) APPARATUS AND METHOD FOR SYNCING DEVICE NOTIFICATIONS

(71) Applicant: SAMSUNG ELECTRONICS CO., LTD., Suwon-si (KR)

(72) Inventor: Alan George LOBO, Somerville, NJ (US)

(73) Assignee: SAMSUNG ELECTRONICS CO. LTD., Suwon-si (KR)

(21) Appl. No.: 13/759,397

(22) Filed: Feb. 5, 2013

(51) Int. Cl. H04L 12/58

(52) U.S. Cl. CPC H04L 51/24
USPC 709/217

(57) ABSTRACT

An apparatus, system, and method for syncing a notification across at least two electronic devices are provided. The method includes pairing a receiving electronic device with at least one electronic device connected to a network, transmitting to the receiving electronic device data indicating that a notification has been generated on a corresponding one of the at least one electronic device paired with the receiving electronic device, and generating a synced notification based on the received data.

### BACKGROUND OF THE INVENTION

1. Field of the Invention

The present invention relates to an apparatus and method for syncing a plurality of devices. More particularly, the present invention relates to an apparatus and method for syncing notifications across synced devices such that a device receives notifications associated with another device with which the device is synced.

2. Description of the Related Art

Electronic devices, such as mobile terminals, have become increasingly important in our everyday lives. For example, electronic devices are used for provide functions such as performing communications, managing schedules and/or calendars, playing multimedia, and executing various applications.

As an example, an electronic device may communicate with other devices across a network (e.g., a home network, a cellular network, the Internet, and the like). The communications may include a phone call (e.g., voice and/or video), a Short Messaging Service (SMS), a Multimedia Message Service (MMS), E-mail, instant messaging, and the like. According to the related art, when an electronic device receives a communication, the electronic device generates an alert or a notification so as to alert a user of an incoming communication.

An electronic device may manage a schedule and/or calendar. For example, the electronic device may enable a user to manage the user's appointments or other events. The function associated with managing the schedule and/or calendar allows the user to add appointments (or events) to the user's calendar. An additional feature associated with the managing of the user's schedule and/or calendar is to generate an alert or notification that reminds the user of an upcoming appointment (or event).

According to the related art, when an electronic device generates an alert or notification, the alert or notification may be an audio alert, a video alert (e.g., an icon or some other indicia being displayed on a display unit), a vibration alert, and the like.

A user may have a plurality of electronic devices each of which includes functionality for notifying or alerting a user of an event (e.g., an incoming communication, an upcoming appointment, and the like). Each of the plurality of devices may be connected to a network (e.g., the Internet, a cellular network, and the like) or service to which another of the plurality of electronic devices is not connected. Consequently, if the user is not holding or otherwise within proximity of one of the plurality of electronic devices, the user may not be adequately notified of a notification generated by or an event occurring on such an electronic device. According to the related art, a user must check each device for new notifications. Each of the devices may have a lot of data corresponding to notifications, such as an indication of installed/uninstalled packages, ongoing settings information, new chat messages, missed calls, calendar events, incoming email, and the like. Further, according to the related art, the user may not focus solely on one device without being concerned that new unattended important notifications are received on the various other electronic devices.

Accordingly, there is a need for an apparatus, system, and method for syncing notifications across electronic devices. For example, there is a need for an apparatus, system, and method for syncing electronic devices such that a device receives notifications associated with another device with which the device is synced.

### SUMMARY OF THE INVENTION

Aspects of the present invention are to address at least the above-mentioned problems and/or disadvantages and to provide at least the advantages described below. Accordingly, an aspect of the present invention is to provide an apparatus, system, and method for syncing notifications across devices.

In accordance with an aspect of the present invention, a method for syncing a notification with at least one electronic device is provided. The method includes pairing a receiving electronic device with at least one electronic device connected to a network, transmitting to the receiving electronic device data indicating that a notification has been generated on a corresponding one of the at least one electronic device paired with the receiving electronic device, and generating a synced notification based on the received data.

In accordance with another aspect of the present invention, a mobile terminal for syncing a notification with at least one electronic device is provided. The mobile terminal includes a communication unit for operatively communicating with at least one electronic device connected to a network, and a controller for pairing the mobile terminal with the at least one electronic device, for receiving data indicating that a notification has been generated on a corresponding one of the at least one electronic device paired with the mobile terminal, and for generating a synced notification based on the received data.

In accordance with another aspect of the present invention, an electronic device for syncing a notification with at least one mobile terminal is provided. The apparatus includes a communication unit for operatively communicating with the mobile terminal over a network, and a controller for pairing the electronic device with the mobile terminal, for generating a notification according to an event, and for transmitting data indicating that a notification has been generated on the electronic device to the mobile terminal

In accordance with another aspect of the present invention, a system for syncing a notification with at least one electronic device is provided. The system includes an electronic device that is configured to detect an event and to generate a notification according to the event, a mobile terminal that is configured to pair with the electronic device, and a networking apparatus for establishing a network over which the electronic device and the mobile terminal communicate, wherein the electronic device transmits to the mobile terminal data indicating that the notification has been generated, and wherein the mobile terminal receives the data indicating the notification has been generated on the electronic device, and generates a synced notification to alert a user that the corresponding event has occurred on the electronic device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a system for syncing notifications across electronic devices according to an exemplary embodiment of the present invention;

FIG. 2 is a diagram illustrating a configuration for managing settings for syncing notifications across electronic devices according to an exemplary embodiment of the present invention; and

FIG. 3 is a flowchart illustrating a method for syncing notifications across electronic devices according to an exemplary embodiment of the present invention; and

FIG. 4 is a block diagram schematically illustrating a configuration of an electronic device according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus, system, and method for syncing notifications across electronic devices. Further, exemplary embodiments of the present invention include an apparatus, system, and method for syncing electronic devices such that a device receives notifications associated with another device with which the device is synced. For example, exemplary embodiments of the present invention include an apparatus, system, and method for syncing a mobile terminal with an electronic device such that mobile terminal notifications associated with events occurring on the electronic device.

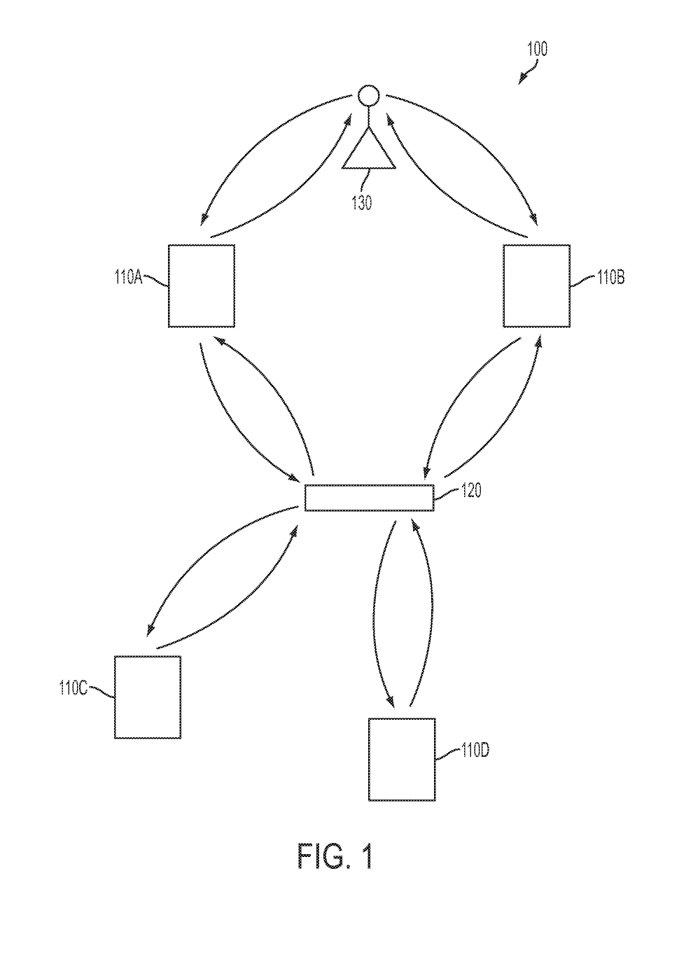

FIG. 1 is a diagram illustrating a system for syncing notifications across electronic devices according to an exemplary embodiment of the present invention.

Referring to FIG. 1, a system 100 for syncing notifications across electronic devices includes a plurality of electronic devices 110A, 110B, 110C, and 110D.

According to exemplary embodiments of the present invention, the plurality of electronic devices 110A, 110B, 110C, and 110D are interconnected. For example, the plurality of electronic devices 110A, 110B, 110C, and 110D may be connected to a networking apparatus 120 (e.g., a router, a base station, and the like). Each of the plurality of electronic devices 110A, 110B, 110C, and 110D may be connected to the networking apparatus 120 via a wired connection and/or via a wireless connection. The networking apparatus 120 may form a network (e.g., a home network, and the like) over which the plurality of electronic devices 110A, 110B, 110C, and 110D may be connected.

According to exemplary embodiments of the present invention, at least two of the plurality of electronic devices 110A, 110B, 110C, and 110D may be synced. As an example, when at least two electronic devices are synced, the electronic devices are configured such that the notifications on at least one of the synced electronic devices may be synced (e.g., shared, forwarded, and/or the like) with another of the synced electronic devices. When at least two electronic devices are synced, one of the electronic devices (e.g., a receiving electronic device) receives a notification or alert of a notification or alert generated on another of the electronic devices (e.g., a sending electronic device) to which the receiving electronic device is synced.

According to exemplary embodiments of the present invention, each of the plurality of electronic devices 110A, 110B, 110C, and 110D may be configured to so as to identify with which of the plurality of electronic devices 110A, 110B, 110C, and 110D to sync.

According to exemplary embodiments of the present invention, an electronic device may be configured to automatically select which of the plurality of electronic devices on the network to which the electronic device should sync (or pair). For example, the electronic device may comprise an authorization profile identifying which other electronic devices are permitted to sync (or pair) therewith, and which notifications may be synced across specified synced electronic devices.

According exemplary embodiments of the present invention, the electronic device may be configured such that a user may select the at least one other electronic device to which the electronic device should sync. For example, the electronic device may scan the network to identify the other electronic devices connected thereto. An electronic device may identify the other plurality of electronic devices connected via the network. The electronic device may enable the user to select which of the other plurality of electronic devices connected via the network to which the electronic device should be synced. Further, the electronic device may enable the user to select which notifications should be synced across electronic devices. The electronic device may enable the user to configure which notifications to share (e.g., transmit or send) to other synced electronic devices. The electronic device may also enable the user to configure which notifications to receive from other synced electronic devices.

According to exemplary embodiments of the present invention, if a receiving electronic device is synced (or paired) with a sending electronic device, when an event occurs at the sending electronic device for which a notification is generated thereon, the sending electronic device sends data associated with the notification to the receiving electronic device.

According to exemplary embodiments of the present invention, if a receiving electronic device is synced (or paired) with a sending electronic device, then the receiving electronic device may generate a synced notification when the receiving electronic device receives data associated with a notification from the sending electronic device. The synced notification may appear within an application that manages the syncing (or pairing) of electronic devices. The synced notification may also appear along native notifications that are generated by the receiving electronic device and that are based on an event on the receiving electronic device. As an example, the synced notification may include an indicia indicating that the synced notification is a notification from another electronic device (e.g., to which the receiving electronic device is synced or paired).

According to exemplary embodiments of the present invention, a notification may be generated based on a missed call, the reception of a new message (e.g., a voicemail, an E-mail, an instant message, a Short Message Service (SMS), a Multimedia Message Service (MMS), and the like), a calendar event, and the like. For example, electronic devices may be connected to more than one network. With reference to FIG. 1, electronic devices 110A and 110B are connected to the network formed by networking apparatus 120 and are connected to a base station 130 which provides voice and/or data communication service with a cellular network. Electronic devices 110A and 110B may receive notifications for events that occur based on communication with the base station 130 (e.g., a missed call, an incoming call, and the like). If electronic device 110C is synced (or paired) with electronic device 110A, then electronic device 110C may receive synced notifications corresponding to notifications occurring at electronic device 110A (e.g., a missed call, an incoming call, and the like).

According to exemplary embodiments of the present invention, the receiving electronic device may be configured such that the user may respond to the synced notification via the sending electronic device. For example, the user may input data corresponding to a response to the synced notification. Thereafter, the receiving electronic device may transmit data corresponding to the response to the synced notification to the sending electronic device, which then performs an appropriate action based on the response. For example, if the notification is a reminder of an upcoming calendar event, the user may input to the receiving electronic device an input to dismiss the calendar event. The receiving electronic device then transmits data to the sending electronic device from which the sending electronic device determines to dismiss the calendar event. As another example, the user may input to the receiving electronic device a request to snooze the reminder for the upcoming calendar event. The receiving electronic device correspondingly transmits to the sending electronic device a request to snooze the reminder upcoming calendar event. As another example, the user may respond use the receiving electronic device to respond to a message (e.g., a voicemail, an E-mail, an instant message, an SMS, an MMS, and the like) received by the sending electronic device.

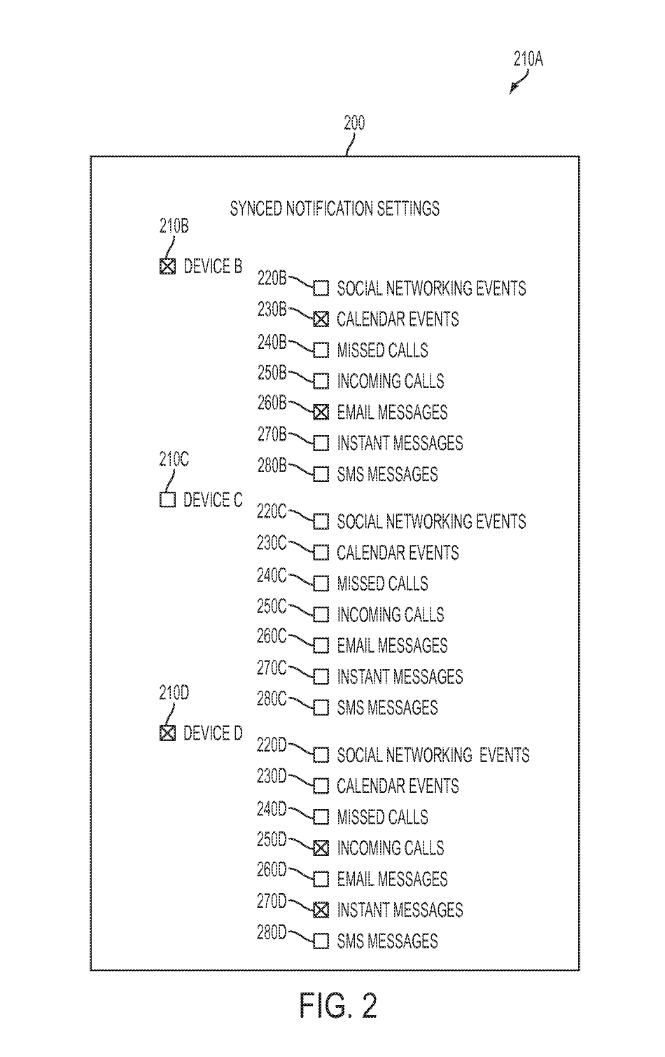

FIG. 2 is a diagram illustrating a configuration for managing settings for syncing notifications across electronic devices according to an exemplary embodiment of the present invention.

Referring to FIG. 2, Device A 210A includes a configuration for managing settings for syncing notifications across electronic devices which includes a synced notification settings screen 200.

According to exemplary embodiments of the present invention, the synced notification settings screen 200 may provide a list of electronic devices from which a user may select electronic devices to which the electronic device is to be synced (or paired). Check boxes 210B, 210C, and 210D may be used to select those electronic devices to which the user wants to sync (or pair). For example, with reference to FIG. 2, check boxes 210B and 210D are selected thereby indicating that the user wants to sync (or pair) with Device B and Device D; check box 210C is unchecked.

The synced notification settings screen 200 may list of electronic devices connected to the same network (e.g., the network formed by the networking apparatus 120). The synced notification settings screen 200 may list only those electronic devices that are configured to sync (or pair) with another electronic device. The synced notification setting screen 200 may list only those electronic devices to which the user (or the electronic device that the user is using) has permission or authorization to sync (or pair). The synced notifications settings screen 200 may list only those electronic devices with which the user's electronic device is already synced (or paired).

According to exemplary embodiments of the present invention, the synced notification setting screen 200 may provide a list of notifications generated on a corresponding sending electronic device for which the user wants to sync. For example, with reference to FIG. 2, the synced notification settings screen 200 may include a list of notifications for each potential sending electronic device to which the receiving electronic device may be synced (or paired). The list of notifications may include social networking events (220B, 220C, and 220D), calendar events (230B, 230C, and 230D), missed calls (240B, 240C, and 240D), incoming calls (250B, 250C, and 250D), email messages (260B, 260C, and 260D), instant messages (270B, 270C, and 270D), SMS messages (280B, 280C, and 280D), and the like. The user may select which notifications are to be synced across electronic devices. For example, with reference to FIG. 2, check boxes 230B and 260B are checked. Accordingly, notifications corresponding to calendar events and email messages that are generated on Device B will be transmitted and synced with the receiving electronic device. Similarly, because check boxes 250D and 270D are checked, notifications for incoming calls and instant messages to Device D will be transmitted and synced with the receiving electronic device. All other notifications generated on Device B, Device C, and Device D will not be synced with the receiving electronic device.

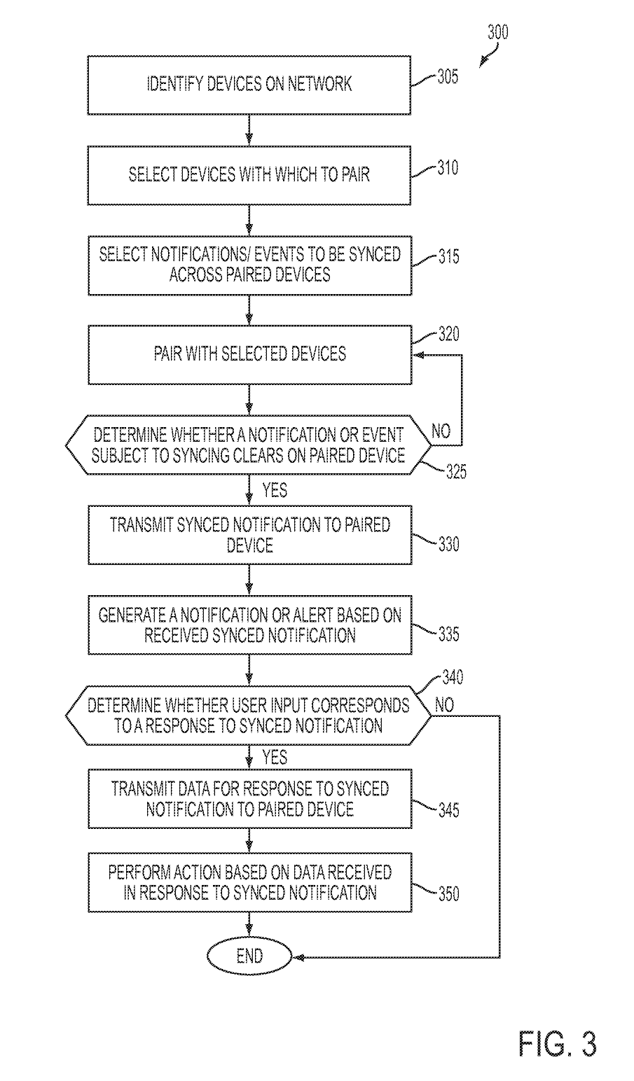

FIG. 3 is a flowchart illustrating a method for syncing notifications across electronic devices according to an exemplary embodiment of the present invention.

Referring to FIG. 3, an electronic device (e.g., the receiving electronic device) identifies a plurality of electronic devices connected to a network in step 305. For example, the receiving electronic device may scan the network and identify all electronic devices connected to the network. As another example, the receiving electronic device may identify all electronic devices that are connected to the network and that are configured to be synced (or paired) for syncing notifications. As yet another example, the receiving electronic device may identify all electronic devices that are connected to the network and that also are configured to permit or authorize the specific receiving device to sync (or pair) therewith.

In step 310, the receiving electronic device selects at least one electronic device with which the receiving electronic device will sync (or pair). The receiving electronic device may automatically select the at least one electronic device with which the receiving electronic device will sync (or pair). For example, the receiving electronic device may use an authorization or permission profile to identify the at least one electronic device with which the receiving electronic device will sync (or pair). The receiving electronic device may also select the at least one electronic device with which the receiving electronic device will sync (or pair) based on user input.

In step 315, the receiving electronic device selects which notifications or events that are to be synced across the synced (or paired) electronic devices. For example, the receiving electronic device may select which notifications or events to sync with the at least one electronic device paired with the receiving electronic device based on input from the user. As another example, the receiving electronic device may select which notifications or events to sync across electronic device based on a predefined configuration of the receiving electronic device or based on an authorization or permission profile of at least one of the receiving electronic device and the at least one electronic device with which the receiving electronic device will sync (or pair).

In step 320, the receiving electronic device syncs (or pairs) with the at least one electronic device with which the receiving electronic device will sync (or pair). For example, the receiving electronic device connects with the at least one electronic device with which the receiving electronic device will sync (or pair) such that data is transmitted therebetween to sync notifications or alerts across the electronic devices.

In step 325, a sending electronic device (e.g., one of the at least one electronic device with which the receiving electronic device is synced) determines whether a notification or event that has been selected to be synced with at least one receiving electronic device occurs (e.g., a synced notification) occurs.

If the sending electronic device determines that a notification or event subject to syncing does not occur in step 325, then the method returns to step 320. Alternatively, according to exemplary embodiments of the present invention, if the sending electronic device determines that a notification or event subject to syncing does not occur in step 325, then the sending electronic device may continue to poll for the occurrence of a synced notification.

If the sending electronic device determines that a notification or event subject to syncing occurs in step 325, then the sending electronic device proceeds to step 330.

In step 330, the sending electronic device transmits data corresponding to the detected notification to the at least one receiving electronic device for which the detected notification is a synced notification between the sending electronic device and the at least one receiving electronic device. For example, the sending electronic device sends data relating to the synced notification to the at least one receiving electronic device that is paired with the at least one receiving electronic device.

In step 335, upon reception of the data relating to the synced notification, the receiving electronic device generates a notification or alert based on the received synced notification. For example, the receiving electronic device alerts a user that a notification or event has occurred on a sending electronic device to which the receiving electronic device is synced (or paired). The receiving electronic device may alert the user using an audio alert, a video alert, a vibration, and the like.

In step 340, the receiving electronic device determines whether the user inputs a command or instruction to respond to the synced notification. For example, the receiving electronic device may determine whether the user inputs a request to dismiss the synced notification locally vis a vis the receiving electronic device, a request to dismiss the synced notification on the sending electronic device, a request to respond to the synced notification by leveraging the functionality of the sending electronic device, and the like. For example, the receiving electronic device may determine whether the user inputs a command to respond to the event from which the synced notification originates. If the event is the reception by the sending electronic device of a Short Message Service (SMS) message (or the like) via a cellular network, the input to the receiving electronic device associated with responding to the synced notification may include instructions for the sending electronic device to transmit a response to the SMS, and data associated with the intended response. If the event is a reminder for a calendar event, the input to the receiving electronic device associated with responding to the synced notification may include instructions for the sending electronic device to snooze the reminder, or to dismiss the reminder.

If the receiving electronic device determines that no input corresponding to a command or instruction to respond to the synced notification is input in step 340, then the receiving electronic device may proceed to end the process. For example, the receiving electronic may determined that no input corresponding to a command or instruction to respond to the synced notification is input if no input is received within a predefined period of time from the time that the receiving electronic device alerts the user of the synced notification.

If the receiving electronic device determines that an input corresponding to a command or instruction to respond to the synced notification is input in step 340, then the receiving electronic device proceeds to step 345.

In step 345, the receiving electronic device transmits to the sending electronic device (e.g., the electronic device on which the notification originated) data relating to the response to the synced notification. For example, if the event is the reception by the sending electronic device of a SMS message (or the like) via a cellular network, the data relating to the response to the synced notification may include instructions for the sending electronic device to transmit a response to the SMS, and data associated with the intended response. If the event is a reminder for a calendar event, the data relating to the response to the synced notification may include instructions for the sending electronic device to snooze the reminder, or to dismiss the reminder.

In step 350, upon reception of the data relating to the response to the synced notification from the receiving electronic device, the sending electronic device performs an action based on the data relating to the response to the synced notification. For example, if the data relating to the response to the synced notification corresponds to an instruction for the sending electronic device to dismiss the notification, then the sending electronic device dismisses the notification. As another example, if the data relating to the response to the synced notification corresponds to an instruction to respond to the event from which the notification originated, then the sending electronic device responds to the event according to the data relating to the response to the synced notification. Thereafter, the method terminates.

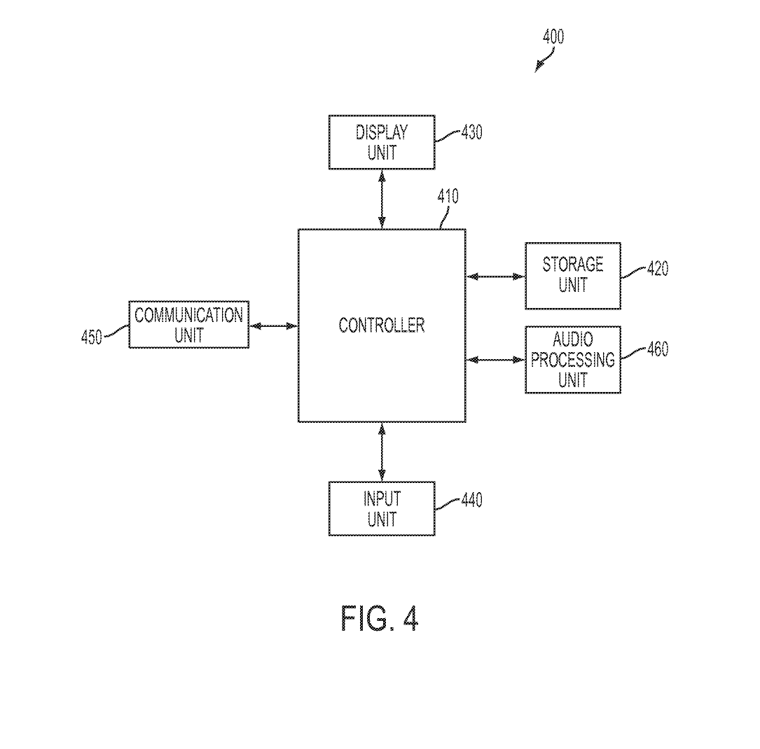

FIG. 4 is a block diagram schematically illustrating a configuration of a electronic device according to exemplary embodiments of the present invention.

Referring to FIG. 4, the electronic device 400 includes a controller 410, a storage unit 420, a display unit 430, an input unit 440, and a communication unit 450. According to exemplary embodiments of the present invention, the electronic device 400 may also include an audio processing unit 460.

According to exemplary embodiments of the present invention, when the electronic device 400 is a receiving electronic device, the electronic device 400 may be configured to sync (or pair) with a sending electronic device for syncing notifications that are generated on the sending electronic device.

According to exemplary embodiments of the present invention, when the electronic device 400 is a sending electronic device, the electronic device 400 may be configured to sync (or pair) with a receiving electronic device for syncing notifications that are generated in the electronic device 400.

According to exemplary embodiments of the present invention, when the electronic device 400 is a receiving electronic device, the electronic device 400 may be configured to receive input from a user. The input from the user may correspond to instructions relating to the synced notification. For example, the input may correspond to a request to dismiss the synced notification locally vis a vis the receiving electronic device, a request to dismiss the synced notification on the sending electronic device, a request to respond to the synced notification by leveraging the functionality of the sending electronic device, and the like.

According to exemplary embodiments of the present invention, when the electronic device 400 is a sending electronic device, the electronic device 400 is configured to receive data relating to the response to the synced notification from the receiving electronic device. The electronic device 400 performs an action based on the data relating to the response to the synced notification. For example, if the data relating to the response to the synced notification corresponds to an instruction for the sending electronic device to dismiss the notification, then the electronic device 400 dismisses the notification. As another example, if the data relating to the response to the synced notification corresponds to an instruction to respond to the event from which the notification originated, then the electronic device 400 responds to the event according to the data relating to the response to the synced notification.

According to exemplary embodiments of the present invention, the mobile terminal comprises at least one controller 410. The at least one controller 410 may be configured to operatively control the electronic device 400. For example, the controller 410 may control operation of the various components or units included in the electronic device 400. The controller 410 may transmit a signal to the various components included in the electronic device 400 and control a signal flow between internal blocks of the electronic device 400. In particular, the controller 410 according to exemplary embodiments of the present invention can control the identification and selection of electronic devices with which the electronic device 400 is to be synced (or paired), control the syncing (or pairing) of the electronic device 400 with at least one other electronic device that is operatively connected to the electronic device 400 via a network, control the selection of notifications to sync across the paired electronic devices, control the syncing of the notification across the paired electronic devices (e.g., the electronic device 400 and the at least one electronic device with which the electronic device 400 is paired), and control the electronic device 400 to take specific actions regarding the synced notification based on input from a user or based on a predefined configuration.

The storage unit 420 can store user data, and the like, as well as a program which performs operating functions according to an exemplary embodiment of the present invention. The storage unit may include a non-transitory computer-readable storage medium. As an example, the storage unit 420 may store a program for controlling general operation of a electronic device 400, an Operating System (OS) which boots the electronic device 400, an application program for performing other optional functions such as a camera function, a sound replay function, an image or video replay function, a pairing function, a notification syncing function, and the like. Further, the storage unit 420 may store user data generated according to a user of the electronic device, such as, for example, a text message, a game file, a music file, a movie file, and the like. In particular, the storage unit 420 according to exemplary embodiments of the present invention may store an application that alert a user when a notification is generated on an electronic device to which the electronic device 400 is paired. For example, the storage unit 420 may store a syncing or pairing application for pairing the electronic device 400 with at least one other electronic device. The syncing or pairing application may transmit to the electronic device 400 data from an electronic device on which a notification subject to syncing occurs. The syncing or pairing application may generate a synced notification on the receiving electronic device which corresponds to the notification of the event occurring at the sending electronic device.

The display unit 430 displays information inputted by user or information to be provided to user as well as various menus of the electronic device 400. For example, the display unit 430 may provide various screens according to a user of the electronic device 400, such as an idle screen, a message writing screen, a calling screen, a notification screen, a synced notification settings screen, and the like. In particular, the display unit 430 according to exemplary embodiments of the present invention can display a menu. The menu may include a list of functions relating to the synced notifications of the electronic device 400. For example, the menu may include a list including a function for selecting at least one electronic device to which the electronic device 400 is to be synced (or paired), a function for selecting at least a notification to be synced across electronic devices (e.g., between the electronic device 400 and the at least one electronic device to which the electronic device 400 is paired), a function for displaying a synced notification upon reception of data indicating that the sending electronic device has received a notification, a function for receiving input relating to a response to the synced notification, a function for transmitting data corresponding to the response to the synced notification to the sending electronic device, and the like. For example, the display unit 430 may display an interface which the user may manipulate or otherwise enter inputs via a touch screen to enter selection of the function relating to the signal strength of the electronic device 400. The display unit 430 can be formed as a Liquid Crystal Display (LCD), an Organic Light Emitting Diode (OLED), an Active Matrix Organic Light Emitting Diode (AMOLED), and the like. However, exemplary embodiments of the present invention are not limited to these examples. Further, the display unit 430 can perform the function of the input unit 440 if the display unit 430 is formed as a touch screen.

The input unit 440 may include input keys and function keys for receiving user input. For example, the input unit 440 may include input keys and function keys for receiving an input of numbers or various sets of letter information, setting various functions, and controlling functions of the electronic device 400. For example, the input unit 440 may include a calling key for requesting a voice call, a video call request key for requesting a video call, a termination key for requesting termination of a voice call or a video call, a volume key for adjusting output volume of an audio signal, a direction key, and the like. In particular, the input unit 440 according to exemplary embodiments of the present invention may transmit to the controller 410 signals related to selection or setting of functions relating to the syncing of notification across electronic devices, functions relating to the response to the synced notifications, and the like. Such an input unit 440 may be formed by one or a combination of input means such as a touch pad, a touchscreen, a button-type key pad, a joystick, a wheel key, and the like.

The communication unit 450 may be configured for communicating with other devices. For example, the communication unit 450 may be configured to communicate via Bluetooth technology, WiFi technology, or another wireless technology.

The audio processing unit 460 may be formed as an acoustic component. The audio processing unit 460 transmits and receives audio signals, and encodes and decodes the audio signals. For example, the audio processing unit 460 may include a CODEC and an audio amplifier. The audio processing unit 460 is connected to a Microphone (MIC) and a Speaker (SPK). The audio processing unit 460 converts analog voice signals inputted from the Microphone (MIC) into digital voice signals, generates corresponding data for the digital voice signals, and transmits the data to the controller 410. Further, the audio processing unit 460 converts digital voice signals inputted from the controller 410 into analog voice signals, and outputs the analog voice signals through the Speaker (SPK). Further, the audio processing unit 460 may output various audio signals generated in the electronic device 400 through the Speaker (SPK). For example, the audio processing unit 460 can output audio signals according to an audio file (e.g. MP3 file) replay, a moving picture file replay, and the like through the speaker. In particular, according to exemplary embodiments of the present invention, the audio processing unit may output an alert such as, for example, an alert indicating a synced notification has been received (e.g., indicating that a sending electronic device has generated a notification based on an event for which notifications are synced across the electronic devices). According to exemplary embodiments of the present invention, the audio processing unit 470 may output a prompt for an indication as to whether data relating to a response to the synced notification should be transmitted to the sending electronic device.

As a non-exhaustive illustration only, an electronic device described herein may refer to a mobile terminal (e.g., mobile device) such as a cellular phone, a personal digital assistant (PDA), a digital camera, a portable game console, an MP3 player, a Portable/Personal Multimedia Player (PMP), a handheld e-book, a portable lap-top Personal Computer (PC), a tablet PC, a Global Positioning System (GPS) navigation, and the like capable of wireless communication or network communication consistent with that disclosed herein. An electronic device may also refer to a devices such as a desktop PC, a high definition television (HDTV), an optical disc player, a setup box, and the like capable of wireless communication or network communication consistent with that disclosed herein.

Program instructions to perform a method described herein, or one or more operations thereof, may be recorded, stored, or fixed in one or more non-transitory computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for syncing a notification across at least two electronic devices, the method comprising:
pairing a receiving electronic device with at least one electronic device connected to a network;
transmitting to the receiving electronic device data indicating that a notification has been generated on a corresponding one of the at least one electronic device paired with the receiving electronic device; and
generating a synced notification based on the received data.

2. The method of claim 1, wherein the pairing of the receiving electronic device with at least one electronic device comprises:
identifying at least one electronic device that is configured to pair with the receiving electronic device.

3. The method of clam 2, wherein the identifying of the at least one electronic device that is configured to pair with the receiving electronic device comprises:
scanning the network for the at least one electronic device connected thereto.

4. The method of claim 3, wherein the identifying of the at least one electronic device that is configured to pair with the receiving electronic device further comprises:
determining which of the at least one electronic device connected to the network is configured to pair with the receiving electronic device.

5. The method of claim 4, wherein the determining which of the at least one electronic device connected to the network is configured to pair with the receiving electronic device comprises:
analyzing permission profiles of at least one of the receiving electronic device and the at least one electronic device connected to the network.

6. The method of claim 4, wherein the network is a local network formed by a networking apparatus.

7. The method of claim 2, wherein the pairing of the receiving electronic device with the at least one electronic device connected to the network further comprises:
identifying at least one notification to be synced between the receiving electronic device and at least one of the at least one identified electronic device.

8. The method of claim 7, wherein the identifying of the at least one notification to be synced between the receiving electronic device and the at least one of the at least one identified electronic device comprises:
receiving user input for selecting the at least one notification to be synced between the receiving electronic device and at least one of the at least one identified electronic device.

9. The method of claim 1, further comprising:
receiving user input for responding to the synced notification.

10. The method of claim 9, wherein the user input for responding to the synced notification comprises an input for dismissing the synced notification on the receiving electronic device.

11. The method of claim 9, wherein the user input for responding to the synced notification comprises an input for transmitting data to the corresponding one of the at least one electronic device paired with the receiving electronic device, and
wherein the transmitted data includes an instruction for the corresponding one of the at least one of electronic device paired with the receiving electronic device to perform a function locally.

12. The method of claim 11, wherein the function comprises dismissing the notification on the corresponding one of the at least one electronic device paired with the receiving electronic device.

13. The method of claim 11, wherein the function comprises responding to an event from which the notification originated.

14. The method of claim 13, wherein when the event corresponds to a message received by the corresponding one of the at least one electronic device paired with the receiving electronic device, the function comprises transmitting a response to the message.

15. A mobile terminal for syncing a notification with at least one electronic device, the mobile terminal comprising:
a communication unit for operatively communicating with at least one electronic device connected to a network; and
a controller for pairing the mobile terminal with the at least one electronic device, for receiving data indicating that a notification has been generated on a corresponding one of the at least one electronic device paired with the mobile terminal, and for generating a synced notification based on the received data.

16. The mobile terminal of claim 15, wherein the controller is configured to pair the mobile terminal with the at least one electronic device by identifying at least one electronic device that is configured to pair with the mobile terminal.

17. The mobile terminal of claim 16, wherein the controller is configured to identify the at least one electronic device that is configured to pair with the mobile terminal by scanning the network for the at least one electronic device connected thereto.

18. The mobile terminal of claim 17, wherein the controller is configured to identify the at least one electronic device that is configured to pair with the mobile terminal by determining which of the at least one electronic device connected to the network is configured to pair with the mobile terminal.

19. The mobile terminal of claim 18, wherein the controller is configured to determine which of the at least one electronic device connected to the network is configured to pair with the mobile terminal by analyzing permission profiles of at least one of the mobile terminal and the at least one electronic device connected to the network.

20. The mobile terminal of claim 18, wherein the network is a local network formed by a networking apparatus.

21. The mobile terminal of claim 16, wherein the controller is configured to pair the mobile terminal with the at least one electronic device by identifying at least one notification to be synced between the mobile terminal and at least one of the at least one identified electronic device.

22. The mobile terminal of claim 21, wherein the controller identifies the at least one notification to be synced between the mobile terminal and the at least one of the at least one identified electronic device by receiving user input for selecting the at least one notification to be synced between the mobile terminal and the at least one of the at least one identified electronic device.

23. The mobile terminal of claim 15, wherein the controller is further configured to receive user input for responding to the synced notification.

24. The mobile terminal of claim 23, wherein the user input for responding to the synced notification comprises an input for dismissing the synced notification on the mobile terminal.

25. The mobile terminal of claim 23, wherein the user input for responding to the synced notification comprises an input for transmitting data to the corresponding one of the at least one electronic device paired with the mobile terminal, and
wherein the transmitted data includes an instruction for the corresponding one of the at least one of electronic device paired with the mobile terminal to perform a function locally.

26. The mobile terminal of claim 25, wherein the function comprises responding to an event from which the notification originated.

27. The mobile terminal of claim 26, wherein when the event corresponds to a message received by the corresponding one of the at least one electronic device paired with the mobile terminal, the function comprises transmitting a response to the message.

30. An electronic device for syncing a notification with a mobile terminal, the electronic device comprising:
a communication unit for operatively communicating with the mobile terminal over a network; and
a controller for pairing the electronic device with the mobile terminal, for generating a notification according to an event, and for transmitting data indicating that a notification has been generated on the electronic device to the mobile terminal

31. The electronic device of claim 30, wherein the controller is configured to pair the electronic device with the mobile terminal by identifying at least one mobile terminal that is configured to pair with electronic device.

32. The electronic device of claim 31, wherein the controller is configured to identify the at least one mobile terminal that is configured to pair with the electronic device by scanning the network for at least one mobile terminal connected thereto.

33. The electronic device of claim 32, wherein the controller is configured to identify the at least one mobile terminal that is configured to pair with the electronic device by determining which of the at least one mobile terminal connected to the network is configured to pair with the electronic device.

34. The electronic device of claim 33, wherein the controller is configured to determine which of the at least one mobile terminal connected to the network is configured to pair with the electronic device by analyzing permission profiles of at least one of the electronic device and the at least one mobile terminal connected to the network.

35. The electronic device of claim 33, wherein the network is a local network formed by a networking apparatus.

36. The electronic device of claim 31, wherein the controller is configured to pair the electronic device with the at least one mobile terminal by identifying at least one notification to be synced between the electronic device and at least one of the at least one identified mobile terminal

37. The electronic device of claim 36, wherein the controller identifies the at least one notification to be synced between the electronic device and the at least one of the at least one identified mobile terminal by receiving user input for selecting the at least one notification to be synced between the electronic device and the at least one of the at least one identified mobile terminal

38. The electronic device of claim 36, wherein the controller identifies the at least one notification to be synced between the electronic device and the at least one of the at least one identified mobile terminal by receiving data from at least one mobile terminal requesting to pair with the electronic device.

39. The electronic device of claim 15, wherein the controller is further configured to receive data from one of the at least one mobile terminal, and
wherein the data includes an instruction for the electronic device to perform a function locally.

40. The electronic device of claim 39, wherein the function comprises responding to the event from which the notification originated.

41. The electronic device of claim 40, wherein when the event corresponds to a message received by the electronic device, the function comprises transmitting a response to the message.

42. A system for syncing a notification across devices, the system comprising:
an electronic device that is configured to detect an event and to generate a notification according to the event;
a mobile terminal that is configured to pair with the electronic device; and
a networking apparatus for establishing a network over which the electronic device and the mobile terminal communicate,
wherein the electronic device transmits to the mobile terminal data indicating that the notification has been generated, and
wherein the mobile terminal receives the data indicating the notification has been generated on the electronic device, and generates a synced notification to alert a user that the corresponding event has occurred on the electronic device.
